(19) United States
(12) Patent Application Publication
(10) Pub. No.: US 2023/0184441 A1
(43) Pub. Date: Jun. 15, 2023

(54) SYSTEMS AND METHODS FOR A CAMPING STAFF

(71) Applicants: Jennie Melvin, Rock Springs, WY (US); Kent Felderman, Rock Springs, WY (US)

(72) Inventors: Jennie Melvin, Rock Springs, WY (US); Kent Felderman, Rock Springs, WY (US)

(21) Appl. No.: 18/078,826

(22) Filed: Dec. 9, 2022

Related U.S. Application Data
(60) Provisional application No. 63/287,955, filed on Dec. 9, 2021.

(51) Int. Cl. F24B 15/00; A45B 3/00

(52) U.S. Cl. CPC F24B 15/005; A45B 3/00

(57) ABSTRACT

A camping staff includes a body defining a head cavity, an air duct, and a tip duct. The camping staff further includes an air stream generator positioned within the head cavity and coupled in flow communication with the air duct and the tip duct. The air stream generator generates a flow of air that is channeled through the air duct and the tip duct.

### CROSS-REFERENCE TO RELATED APPLICATION

This present application is a Non-Provisional Patent application claiming priority to and the benefit of U.S. Provisional Patent Application No. 63/287,955, filed 9 Dec. 2021, the disclosure of which is hereby incorporated, in its entirety, by this reference.

### BACKGROUND OF CERTAIN ASPECTS OF THE DISCLOSURE

A basic staple of camping and/or fire tending has always been the familiar “camp stick.” Some people take it as a personal challenge to seek out the ultimate, disposable staff for one-time use at each outing. Others prefer a pet stick that has been adopted by the family and kept for all occasions. The latter often inspires customization and personalization by the owner which, over time, can act to strengthen the bond between user and stick. Especially since the camp staff has many functions in the camping experience, far beyond simple fire manipulation (i.e., walking, leaning, balancing, reaching, security, threat deterrent, etc.).

A key function of a good camp stick is building and maintaining a recreational/cooking fire which requires both adequate ventilation and regular manipulation of the fuel supply. Lacking either, the flame will naturally sputter, smolder, and eventually die out prematurely. This can be compounded by adverse conditions such as bad weather; rotten, cheap, or wet fuel materials; or basic inattention. While a healthy campfire always requires a certain amount of regular attention, this process may be greatly simplified and made much more efficient by the use of automated mechanical aeration of the fuel source.

At least some known fire maintenance devices are not convenient, practical, versatile, or stylish. Specifically, at least some known fire maintenance devices have an awkward shape, are carried in an extra pack, or are cumbersome to use because they must be removed from the pack, assembled, used, disassembled, and repacked. Additionally, at least some known fire maintenance devices may include outdated battery technology that makes the device inefficient. Moreover, some fire maintenance devices may require incidental appliances such as power cords and outside power sources. Furthermore, the fire maintenance devices may be noisy and disruptive due to the inefficiencies of the fan motor. Finally, the fire maintenance devices are typically designed only for the purpose of blowing air. They are intended only for accelerating flame and not as an all-around, multi-purpose camp staff.

Accordingly, there is a need for a convenient, efficient camping staff that maintains a fire and provides support while walking.

### BRIEF SUMMARY OF SOME ASPECTS OF THE DISCLOSURE

A number of embodiments of a camping staff are presented in this application. The camping staff includes a body defining a head cavity, an air duct, and a tip duct. The camping staff further includes an air stream generator positioned within the head cavity and coupled in flow communication with the air duct and the tip duct. The air stream generator generates a flow of air that is channeled through the air duct and the tip duct.

The embodiments described herein also include a method of aerating a fire using a camping staff. The camping staff includes a body defining a head cavity, an air duct, and a tip duct and an air stream generator positioned within the head cavity and coupled in flow communication with the air duct and the tip duct. The method includes using the camping staff as a walking stick. The method further includes aiming the tip duct at a fire. The method further includes activating the air stream generator. The method also includes generating a flow of air using the air stream generator. The method further includes directing the flow of air into the fire.

There are other novel aspects and features of this disclosure. They will become apparent as this specification proceeds. Accordingly, this brief summary is provided to introduce a selection of concepts in a simplified form that are further described below in the detailed description. The summary and the background are not intended to identify key concepts or essential aspects of the disclosed subject matter, nor should they be used to constrict or limit the scope of the claims. For example, the scope of the claims should not be limited based on whether the recited subject matter includes any or all aspects noted in the summary and/or addresses any of the issues noted in the background.

### DRAWINGS

The preferred and other embodiments are disclosed in association with the accompanying drawings in which:

FIG. 1 illustrates a schematic cross-sectional view of an example camping staff in accordance with aspects of the present disclosure.

FIG. 2 illustrates a schematic cross-sectional view of a head of the camping staff shown in FIG. 1 in accordance with aspects of the present disclosure.

FIG. 3 illustrates another schematic cross-sectional view of a head of the camping staff shown in FIG. 1 in accordance with aspects of the present disclosure.

FIG. 4 illustrates a schematic side view of a head of the camping staff shown in FIG. 1 in accordance with aspects of the present disclosure.

FIG. 5 illustrates a flow diagram of a method of aerating a fire using the camping staff shown in FIG. 1 in accordance with aspects of the present disclosure.

### DETAILED DESCRIPTION

A number of embodiments of a system and method for a camping staff are provided herein. In general, the camping staff described herein is a durable, self-contained, reusable, multi-purpose camping staff including an electronic air stream generator for flame aeration. Specifically, the camping staff includes a body that resembles the size, shape, balance, feel and appearance of a natural-wood staff. The need for repeated searching for the “perfect” stick is eliminated with the reusable nature of the camping staff described herein. The design is pleasing to the eye, comfortable in the hand, and creates functionality as a walking aid which eliminates the requirement to carry it in a pack and assemble for each use.

The camping staff described herein includes an air stream generator to provide the additional functionality of simplifying the process of fire maintenance. The camping staff is molded with a custom grip for one handed operation, allowing comfortable, efficient manipulation and easy access to the actuator trigger. To operate the camping staff, the user simply squeezes the trigger with the index finger, activating the on-board fan which produces an airflow that travels through the length of the staff and exits at the distal end of the camping staff. The user directs the air to the desired target area utilizing one-handed motions. The camping staff is used for lighting and maintaining recreational fires, smoke abatement, and insect repellant, etc. The amount of air can be adjusted for each application by varying the amount of pressure that is applied to the actuator trigger. The targeted air flow is used as a combustion accelerant and increases the efficiency and simplifies both fire ignition and maintenance.

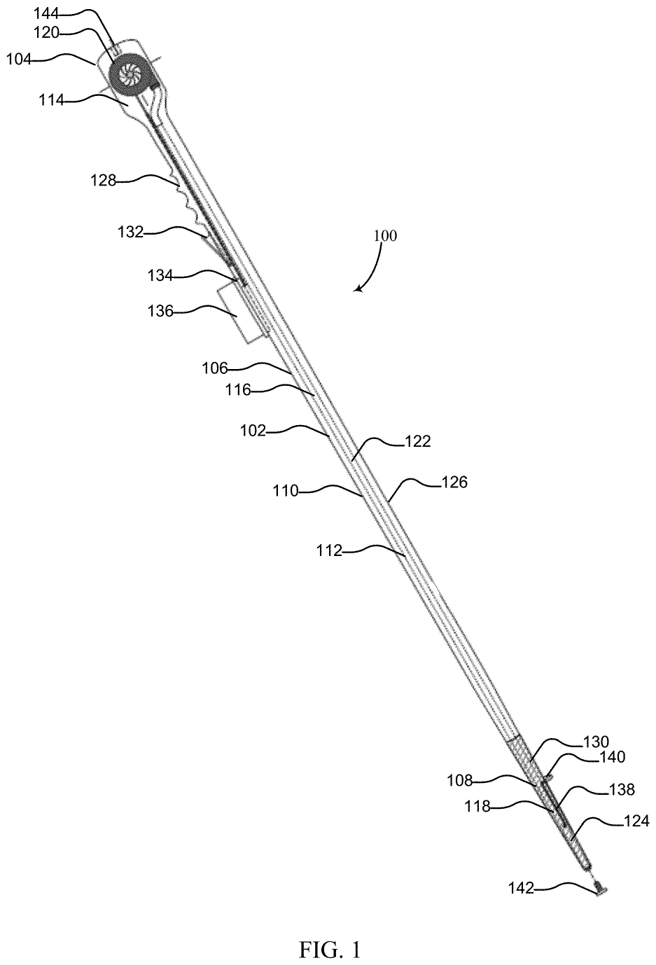

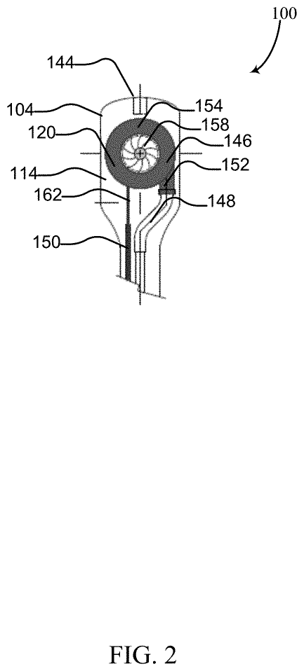

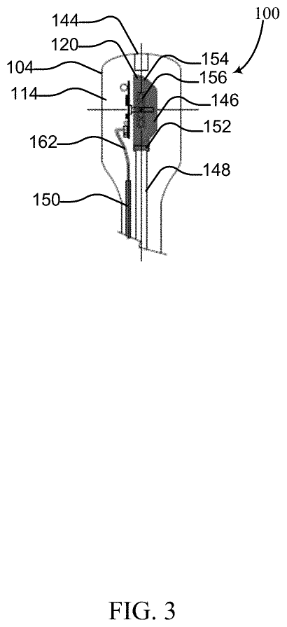

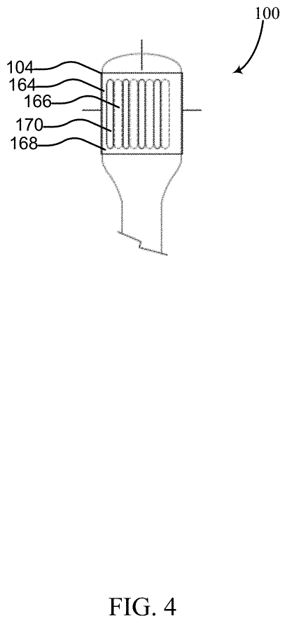

FIG. 1 illustrates a schematic cross-sectional view of an example camping staff 100. FIG. 2 illustrates a schematic cross-sectional view of a head 104 of the camping staff 100. FIG. 3 illustrates another schematic cross-sectional view of the head 104 of the camping staff 100. FIG. 4 illustrates a schematic side view of the heat 104 of the camping staff 100. The camping staff 100 includes a body 102 defining the head 104, a mid-section 106, and a tip 108. The body 102 includes a composite shaft 110 that resembles the size, shape, balance, feel, and appearance of a natural-wood staff. The composite shaft 110 is molded into an elongated, hollow shaft that defines an inner cavity 112 that defines a plurality of cavities 114, 116, and 118 withing the head 104, the mid-section 106, and the tip 108.

The head 104 defines a head cavity 114, the mid-section 106 defines a mid-section cavity 116, and the tip 108 defines a tip cavity 118. The head cavity 114 is sized and shaped to contain an air stream generator 120 therein. The mid-section cavity 116 is sized and shaped to define an air duct 122 therein. The tip cavity 118 is sized and shaped to define a tip duct 124 therein. The head cavity 114, the mid-section cavity 116, and the tip cavity 118 are connected and collectively define the inner cavity 112.

The body 102 also includes an outer surface 126 that has a natural-wood aesthetic to resemble a natural camping staff. Additionally, the camping staff 100 further includes a hand grip 128 attached to the outer surface 126. In the illustrated embodiment, the hand grip 128 includes a rubberized grip to provide an ergonomic grip for the user to hold the camping staff 100. The hand grip 128 is positioned within the mid-section 106 at a comfortable height for the user. The camping staff 100 also includes an aluminum heat shield 130 attached to the tip 108 and configured to shield the tip 108 from heat generated by a fire when the camping staff 100 is used to aerate and maintain a fire.

The camping staff 100 further includes a variable trigger 132 positioned proximate the hand grip 128 and configured to control the air stream generator 120 as described herein. The camping staff 100 further includes battery clips 134 positioned in the mid-section 106 and configured to attach a detachable, rechargeable battery 136 to the body 102. The battery 136 includes a lithium-ion battery configured to power the air stream generator 120 as described herein. The battery 136 may not be attached to the battery clips 134 when the air stream generator 120 is not in use. Additionally, the battery 136 by be recharged by a charging device (not shown) when the battery 136 is detached from the battery clips 134.

The tip 108 includes a tip cleaner 138 positioned within the tip duct 124 for cleaning the tip duct 124. In the illustrated embodiment, the tip cleaner 138 includes a spring-loaded tip cleaner 138 that is machined into the tip duct 124. The spring-loaded tip cleaner 138 includes a tip cleaner lever 140 and an internal rod (not shown). Depressing the tip cleaner lever 140 slides the internal rod downward to evacuate foreign materials that may become lodged in the tip duct 124 from time to time. The tip 108 also includes a screw-on tip plug 142 positioned within the tip duct 124 to protect tip duct 124 from foreign materials when the camping staff 100 is not generating an air flow. For convenience, the tip plug 142 is stored in a receptacle 144 defined in the head 104 of the camping staff 100 when not in use.

As shown in FIGS. 2 and 3, the air stream generator 120 includes an electric fan assembly 146, at least one air duct fitting 148, and a wiring conduit 150. The electric fan assembly 146 is powered by the battery 136 when the battery 136 is attached to the batter clips 134. The electric fan assembly 146 is configured to generate a flow of air to aerate or maintain a fire. The air duct fitting 148 is attached to the electric fan assembly 146 and the air duct 122 and configured to channel the flow of air from the electric fan assembly 146 to the air duct 122. In some embodiments, the air duct fitting 148 includes at least one plastic fitting attached to the electric fan assembly 146 and the air duct 122 and configured to channel the flow of air from the electric fan assembly 146 to the air duct 122. In alternative embodiments, the air duct fitting 148 may be formed of any material that enables the camping staff 100 to operate as described herein. The wiring conduit 150 transmits power from the battery 136 to the electric fan assembly 146 and transmits control signals from the variable trigger 132 to the electric fan assembly 146.

The electric fan assembly 146 includes a compressor 152 including a housing 154, motor coils 156, an impeller or fan 158, a circuit panel 160, and a wire harness 162. The housing 154 contains and protects the motor coils 156, the impeller or fan 158, and the circuit panel 160. The motor coils 156 are powered by the battery 136 and are configured to rotate the impeller or fan 158 within the housing 154. Rotation of the impeller or fan 158 generates the flow of air and the housing 154 and the air duct fitting 148 channel the flow of air from the housing 154 to the air duct 122. The circuit panel 160 controls rotation of the impeller or fan 158. The wire harness 162 connects the wiring conduit 150 to the motor coils 156 and the circuit panel 160.

As shown in FIG. 4, the head 104 includes a louvre system 164 configured to selectively channel air into the head 104 when the compressor 152 is operating. Specifically, the louvre system 164 is opened to enable air to flow into the head 104 and the compressor 152 when the camping staff 100 is aerating or maintain a fire. When the compressor 152 is not in use, the louvre system 164 is closed to prevent foreign materials from entering the head 104. The louvre system 164 includes a plurality of slots 166 defined in the head 104 and a band 168 defining a plurality of corresponding band slots 170. The band 168 circumscribes the head 104 such that, in an open configuration, the band slots 170 align with the slots 166 to enable air to flow into the head 104 and, in a closed configuration, the band slots 170 are misaligned with the slots 166 such that air is prevented from flowing into the head 104. Rotation of the band 168 positions the band 168 in the open and closed configuration.

During operations, the user uses the camping staff 100 as a walking stick or other implement by gripping the grip 128. The user then attaches the battery 136 to the battery clips 134 and removes the tip plug 142 from the tip duct 124 and stores the tip plug 142 in the receptacle 144. The user also opens the louvre system 164 by rotating the band 168. The user then aims the tip 108 toward a fire and depresses the variable trigger 132 to activate the air stream generator 120. The air stream generator 120 generates the flow of air and channels the flow of air into the air duct 122 and the tip duct 124 where the flow of air is discharged into the environment and/or the fire. The user may depress the variable trigger 132 to various positions to vary the flow rate of the flow of air. The user may insert the tip 108 into the fire to otherwise maintain the fire. Once the fire no longer needs tending, the user replaces the tip plug 142 in the tip duct 124 and removes the battery 136 from the battery clip 134. The user then resumes using the amping staff 100 as a walking stick or other implement by gripping the grip 128.

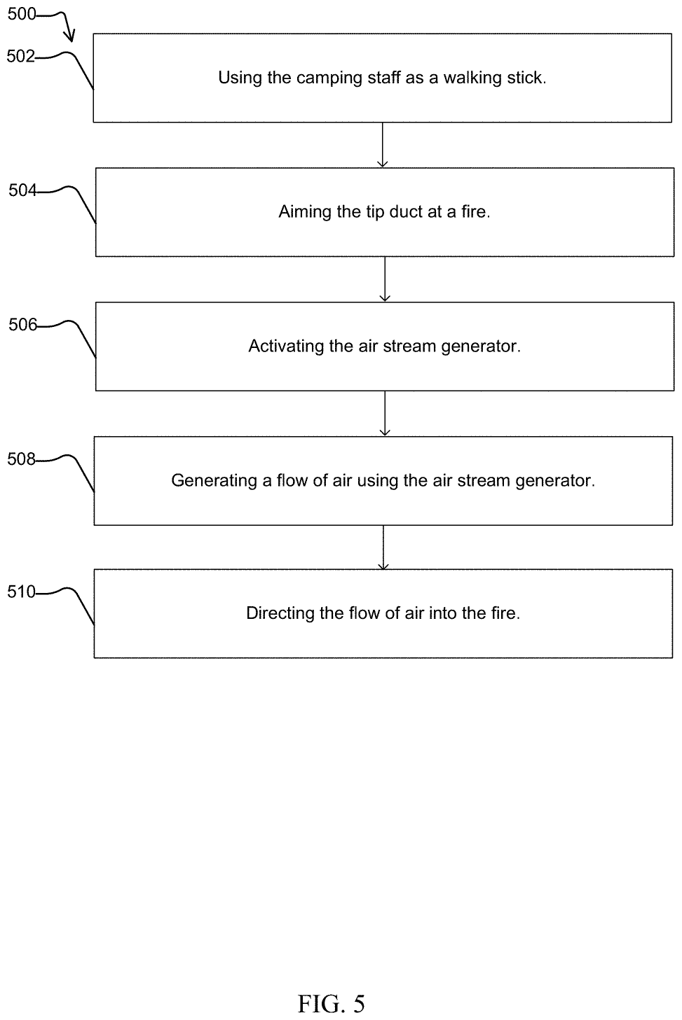

FIG. 5 illustrates a flow diagram of a method 500 of aerating a fire using a camping staff. The camping staff includes a body defining a head cavity, an air duct, and a tip duct and an air stream generator positioned within the head cavity and coupled in flow communication with the air duct and the tip duct. The method 500 includes using 502 the camping staff as a walking stick. The method 500 further includes aiming 504 the tip duct at a fire. The method 500 further includes activating 506 the air stream generator. The method 500 also includes generating 508 a flow of air using the air stream generator. The method 500 further includes directing 510 the flow of air into the fire.

The camping staff described herein is a durable, self-contained, reusable, multi-purpose camping staff including an electronic air stream generator for flame aeration. Specifically, the camping staff includes a body that resembles the size, shape, balance, feel and appearance of a natural-wood staff. The need for repeated searching for the “perfect” stick is eliminated with the reusable nature of the camping staff described herein. The design is pleasing to the eye, comfortable in the hand, and creates functionality as a walking aid which eliminates the requirement to carry it in a pack and assemble for each use.

The camping staff described herein includes an air stream generator to provide the additional functionality of simplifying the process of fire maintenance. The camping staff is molded with a custom grip for one handed operation, allowing comfortable, efficient manipulation and easy access to the actuator trigger. To operate the camping staff, the user simply squeezes the trigger with the index finger, activating the on-board fan which produces an airflow that travels through the length of the staff and exits at the distal end of the camping staff. The user directs the air to the desired target area utilizing one-handed motions. The camping staff is used for lighting and maintaining recreational fires, smoke abatement, and insect repellant, etc. The amount of air can be adjusted for each application by varying the amount of pressure that is applied to the actuator trigger. The targeted air flow is used as a combustion accelerant and increases the efficiency and simplifies both fire ignition and maintenance.

Terminology and Interpretative Conventions

Any methods described in the claims or specification should not be interpreted to require the steps to be performed in a specific order unless stated otherwise. Also, the methods should be interpreted to provide support to perform the recited steps in any order unless stated otherwise.

Spatial or directional terms, such as “left,” “right,” “front,” “back,” and the like, relate to the subject matter as it is shown in the drawings. However, it is to be understood that the described subject matter may assume various alternative orientations and, accordingly, such terms are not to be considered as limiting.

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items.

The terms have, having, include, and including should be interpreted to be synonymous with the terms comprise and comprising. The use of these terms should also be understood as disclosing and providing support for narrower alternative embodiments where these terms are replaced by “consisting” or “consisting essentially of.”

Unless otherwise indicated, all numbers or expressions, such as those expressing dimensions, physical characteristics, and the like, used in the specification (other than the claims) are understood to be modified in all instances by the term “approximately.” At the very least, and not as an attempt to limit the application of the doctrine of equivalents to the claims, each numerical parameter recited in the specification or claims which is modified by the term “approximately” should be construed in light of the number of recited significant digits and by applying ordinary rounding techniques.

All disclosed ranges are to be understood to encompass and provide support for claims that recite any and all subranges or any and all individual values subsumed by each range. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

All disclosed numerical values are to be understood as being variable from 0-100% in either direction and thus provide support for claims that recite such values or any and all ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range (e.g., 15.2).

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

The subject matter recited in the claims is not coextensive with and should not be interpreted to be coextensive with any embodiment, feature, or combination of features described or illustrated in this document. This is true even if only a single embodiment of the feature or combination of features is illustrated and described in this document.

What is claimed:

1. A camping staff comprising:
a body defining a head cavity, an air duct, and a tip duct; and
an air stream generator positioned within the head cavity and coupled in flow communication with the air duct and the tip duct, wherein the air stream generator generates a flow of air that is channeled through the air duct and the tip duct.

2. The camping staff of claim 1, wherein the air stream generator comprises a compressor.

3. The camping staff of claim 2, wherein the compressor comprises a housing and a fan positioned in the housing, wherein the fan is configured to generate the flow of air.

4. The camping staff of claim 3, wherein the compressor further comprises a motor coil positioned within the housing and configured to rotate the fan to generate the flow of air.

5. The camping staff of claim 4, wherein the compressor further comprises a circuit panel configured to control the motor coil.

6. The camping staff of claim 5, wherein the compressor further comprises a wire harness configured to connect the circuit panel to a battery.

7. The camping staff of claim 2, further comprising an air duct fitting attached to the compressor and the air duct, wherein the air duct fitting channels the flow of air from the compressor to the air duct.

8. The camping staff of claim 2, further comprising a louvre system attached to a head of the body, wherein the louvre system is configured to channel air into the compressor.

9. The camping staff of claim 8, wherein the louvre system comprises a plurality of slots defined in the head.

10. The camping staff of claim 9, wherein louvre system further comprises a band circumscribing the head.

11. The camping staff of claim 10, wherein the band defines a plurality of band slots corresponding to the plurality of slots, and wherein, in an open configuration, the band slots align with the slots to enable air to flow into the head.

12. The camping staff of claim 11, wherein, in a closed configuration, the band slots are misaligned with the slots such that air is prevented from flowing into the head.

13. The camping staff of claim 12, wherein rotation of the band reconfigures the louvre system between the open configuration and the closed configuration.

14. The camping staff of claim 1, further comprising a battery clip attached to the body.

15. The camping staff of claim 1, further comprising a battery attached to the battery clip.

16. The camping staff of claim 1, further comprising a grip attached to the body.

17. The camping staff of claim 1, further comprising a tip cleaner positioned within the tip duct.

18. A method of aerating a fire using a camping staff, the camping staff including a body defining a head cavity, an air duct, and a tip duct and an air stream generator positioned within the head cavity and coupled in flow communication with the air duct and the tip duct, the method comprising:
using the camping staff as a walking stick;
aiming the tip duct at a fire;
activating the air stream generator;
generating a flow of air using the air stream generator; and
directing the flow of air into the fire.

19. The method of claim 18, further comprising opening a louvre system.

20. The method of claim 19, further comprising channeling air into the air stream generator through the louvre system.
